(19) United States
(12) Patent Application Publication
(10) Pub. No.: US 2017/0198756 A1
(43) Pub. Date: Jul. 13, 2017

(54) DISENGAGING OVERLOAD CLUTCH WITH LATCHING BY WAY OF MAGNETICALLY LOADED CONTROL ELEMENTS

(71) Applicant: Chr. Mayr GmbH + Co. KG, Mauerstetten (DE)

(72) Inventor: Norbert Vogl, Rott (DE)

(73) Assignee: Chr. Mayr GmbH + Co. KG, Mauerstetten (DE)

(21) Appl. No.: 15/315,444

(22) PCT Filed: Jun. 2, 2015
(86) PCT No.: PCT/EP2015/062272

§ 371 Date: Dec. 1, 2016

(30) Foreign Application Priority Data
Jun. 11, 2014 (DE) 10 2014 008 800.6

(51) Int. Cl. F16D 7/08; F16D 43/206

(52) U.S. Cl. CPC F16D 7/08; F16D 43/206

(57) ABSTRACT

A disengaging overload clutch, having a clutch hub and a pressure flange mounted rotatably and in which transmission bodies are held in the recesses of the pressure flange by way of the force of spring elements and transmit the torque from the pressure flange to the clutch hub. During overload between the clutch hub and the pressure flange, the clutch moves in—a first rotational direction into a disengaged state, wherein the relatching takes place by rotation between the clutch hub and the pressure flange in a second opposite rotational direction; or more precisely by the interaction between the control pins, control cams which are connected to the clutch hub, and control grooves with groove flanks. The control pins are fitted with pin magnets, which are pressed away from control magnets of identical polarity, in order to bring the control pins into engagement with the control cams and the control grooves.

In the field of industrial drive engineering the mechanical overload clutch has established itself as a reliable machine part for preventing damage through excessive torques.

With mechanical overload clutches, depending on the respective mode of use, various concepts of functionality are implemented:
Ratcheting clutches for more simple drives.
Synchronous clutches with true re-engagement angle.
Disengaging clutches with manual re-engagement.
Disengaging clutches with automatic re-engagement.

The object of the herein recited invention is a technical improvement of disengaging clutches with automatic re-engagement according to the preamble of the independent claim.

According to the state of the art disengaging clutches are known for which following activation of the clutch, re-engagement is achieved by slow reverse turning between the drive input side and output side of the clutch.

Such a disengaging clutch is disclosed in DE 37 27 484 C2. In this disengaging clutch according to the state of the art torque transfer follows from a drive input element (here denoted as a pressure flange) through a so-called switch element to a drive output element hereinafter described as a hub. The switch element is, by way of a toothed profile, rotationally attached to the hub yet axially movable.

First balls in an outer reference circle and placed in a ball cage, preferably with equal separation, serve as transfer bodies for the transmission of torque. The first balls, which serve as transfer bodies, are held in the cone-shaped recesses in the pressure flange and switch element by a spring element centralized on the hub.

Upon activation (that is disengagement) of the clutch through exceeding a torque defined by the power of the spring element the first balls migrate out of the cone-formed recesses in the pressure flange and switch element and thereby perform a rolling motion on the surfaces of the recesses. As a result of these rolling motions a rotation between the ball cage (with the first balls located therein) and the switch element likewise between the ball cage and the pressure flange results.

On a separate inner reference circle of the ball cage are arranged support balls which, upon the rotation between the ball cage and the switch element, enter special support recesses in the switch element and thereby prevent re-engagement of the disengaging clutch.

So-called impact bodies hereinafter referred to as control pins, in the known state of the art, are biased towards the switch element through the force of the spring element, are located in bores on a reference circle on the pressure flange and slide on a ramp furnished control cam of the switch element.

After disengagement of the disengaging clutch the switch element and the ball cage find themselves in a relative angular position to each other, wherein the control pins are sliding on the cam and the ramps of the switch element during running down of the disengaging clutch.

After the clutch has come to a halt and the cause of the disruption (the overload) has been eliminated the direction of rotation between the pressure flange and switch element is reversed and there follows a slow reverse rotation between those two parts. Thereby, through the interaction of pressure flange, control pins, switch element and the retaining edges of the ball cage, the ball cage with first and second and balls is rotated back to the original initial position, the disengaging clutch re-engages and is again ready for use.

The disadvantage of the disengaging clutch according to the state of the art as in DE 37 27 484 is the permanent contact between the spring-loaded control pins and the switch element so as with the ball cage. As a result, especially with long run-down times of the disengaging clutch following disengagement as a result of an overload, severe wear results to the control pins and to those parts in working contact with the control pins, especially the switch element and the ball cage. Furthermore, considerable noise results from contact between the control pins and the ramps of the switch element at higher revolutions.

The problem for the present invention, in light of the aforementioned state of the art, is to provide a disengaging clutch for which the wear between the control pins and those parts of the clutch in working contact therewith is significantly reduced and at the same time to greatly reduce the noise production associated therewith.

This problem is solved through a disengaging clutch having the features according to claim 1.

It is therein proposed that rather than as until now the control pin(s) be pressed against those parts of the clutch having a working relationship therewith using spring elements, this be from the force of specially arranged permanent magnets. According to the invention it is provided that first permanent magnets be provided on the end(s) of the control pin(s) remote from the switch element and to place opposite these first permanent magnets second permanent magnets attached to the hub, wherein the first and second permanent magnets are poled such that they mutually repel each other.

Preferably, the second permanent magnet(s) attached at fixed angles on the hub are arranged only in angular positions such that through the functional interaction between the control pins and the switch element a re-engagement of the disengaging clutch is possible.

In all other angular positions the surface opposing the first permanent magnets of the control pins is arranged such that an attraction of this results. This can be achieved simply by composing the surface of a ferromagnetic material or by arranging further third permanent magnets which however as opposed to the first permanent magnets of the cam follower are oppositely poled and thus attract these.

Through this combination the control pins(s) adorned with the first permanent magnets in respective angular positions where re-engagement of the disengaging clutch is not possible through the interaction between the control pins and switch element are held apart from the switch element such that there is no contact thus no resulting wear, nor any noise production.

In one particular advantageous embodiment of the disengaging clutch according to the invention the second permanent magnet(s) which are attached to the hub at fixed angular positions are arranged in the circumferential direction as narrowly as still to allow proper functioning. As a result, in the case of a run down of the disengaging clutch a repulsive force between the first and second magnets is only affective over a very small angle of rotation and that especially for run down from high revolutions movement of the control pins cannot result from this short force impulse. This means that eventually that at high revolutions the control pins no longer touch the parts together with which they work during re-engagement of the disengaging clutch and that the control pins thereby run completely wear-free and without noise.

From DE 42 15 853 A1 and JP H07-27 143 A overload clutches operated using magnets are known, which following exceeding of a limiting torque the clutch can overrun freely and likewise allow the overload clutch to be re-engaged. These documents, however, provide no indication how, as in the present invention, the control pins are influenced or impinged upon by the pin magnets and therefrom separated control magnets.

Further technical details of the invention are given in the following description of the preferred embodiments of the disengaging clutch according to the invention.

These show:

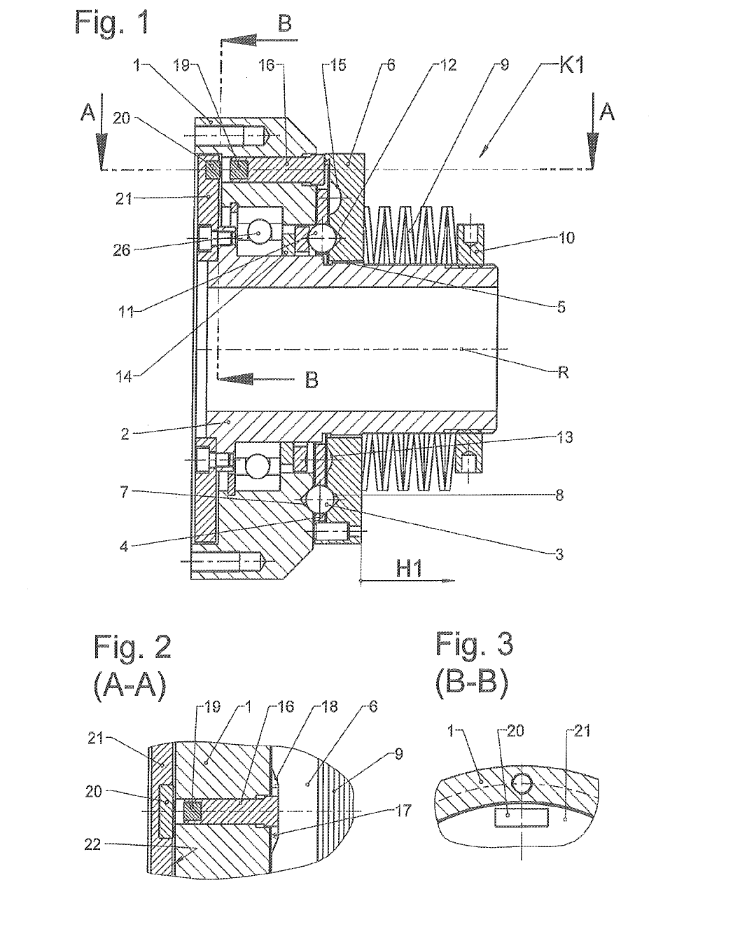

FIG. 1 a longitudinal section through the clutch in the engaged condition, which building on the state of the art is equipped with the additional features of this invention,

FIG. 2 a longitudinal cross section A-A through the clutch of FIG. 1,

FIG. 3 a cross section B-B through the clutch of FIG. 1,

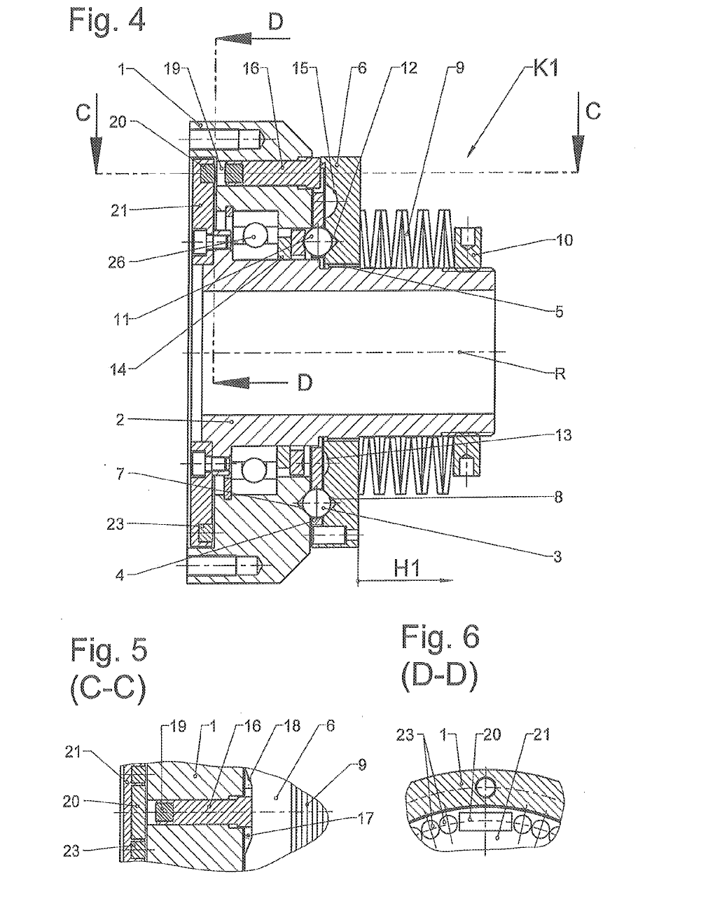

FIG. 4 a view analogous to FIG. 1 additionally equipped with retaining magnets arranged adjacent to the driving magnets in the circumferential direction as can be seen in sections C-C and D-D,

FIG. 5 a longitudinal cross section C-C through the clutch of FIG. 4,

FIG. 6 a cross section D-D through the clutch of FIG. 4,

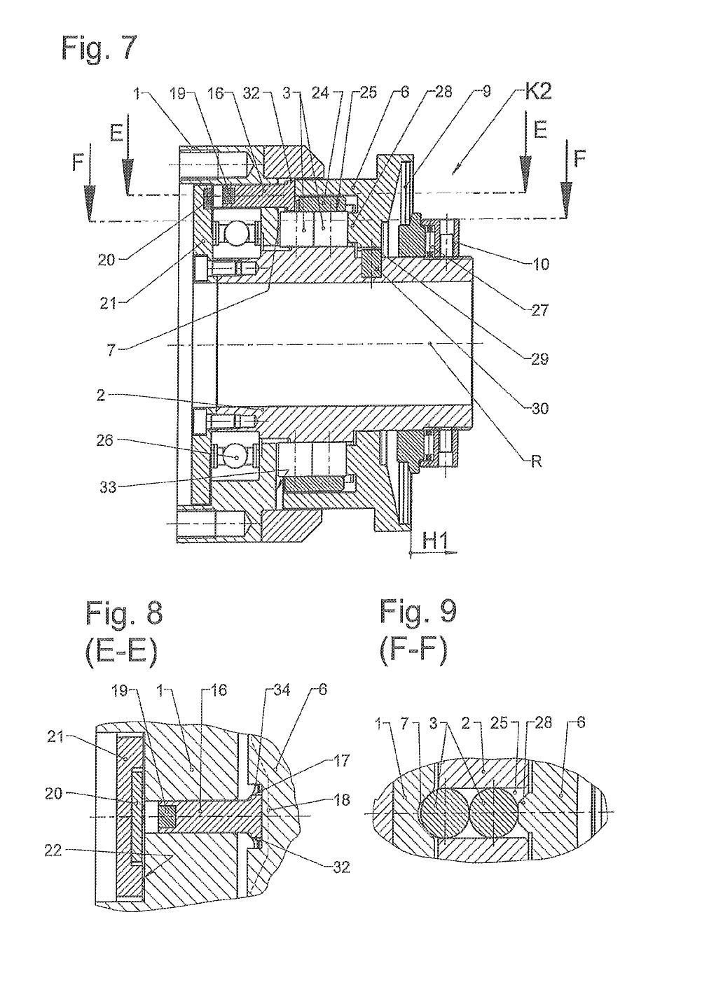

FIG. 7 a longitudinal section through a clutch having two cylindrical rollers for torque transfer and additionally equipped with the features of the invention, wherein the clutch is portrayed in the engaged condition,

FIG. 8 a longitudinal section E-E through the clutch of FIG. 7,

FIG. 9 a further longitudinal section F-F through the clutch of FIG. 7,

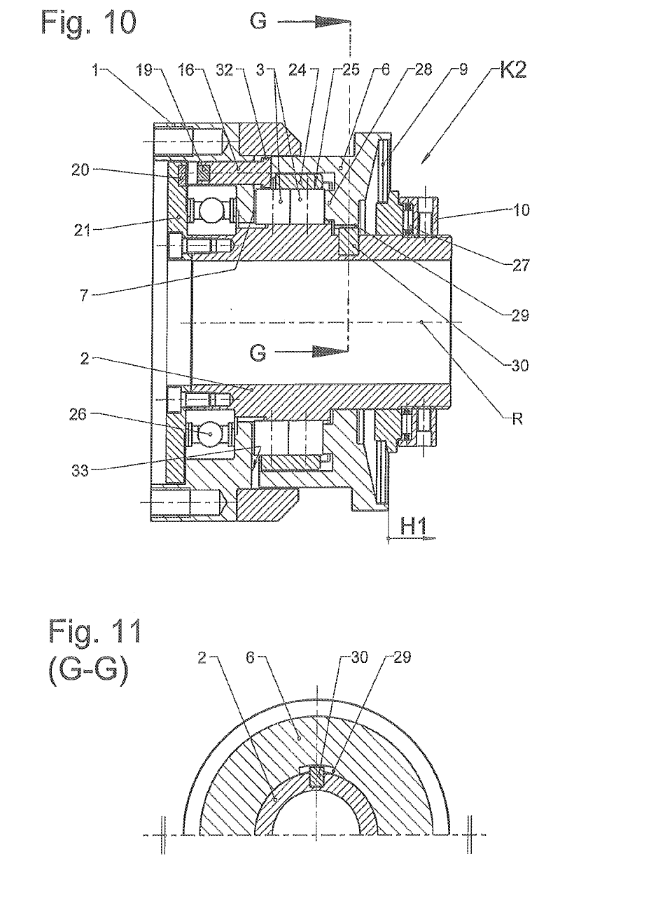

FIG. 10 a further longitudinal section through a clutch having two cylindrical rollers for torque transfer additionally equipped with the features of the invention, wherein the representation shows the clutch in the engaged condition,

FIG. 11 a cross section G-G through the clutch of FIG. 10,

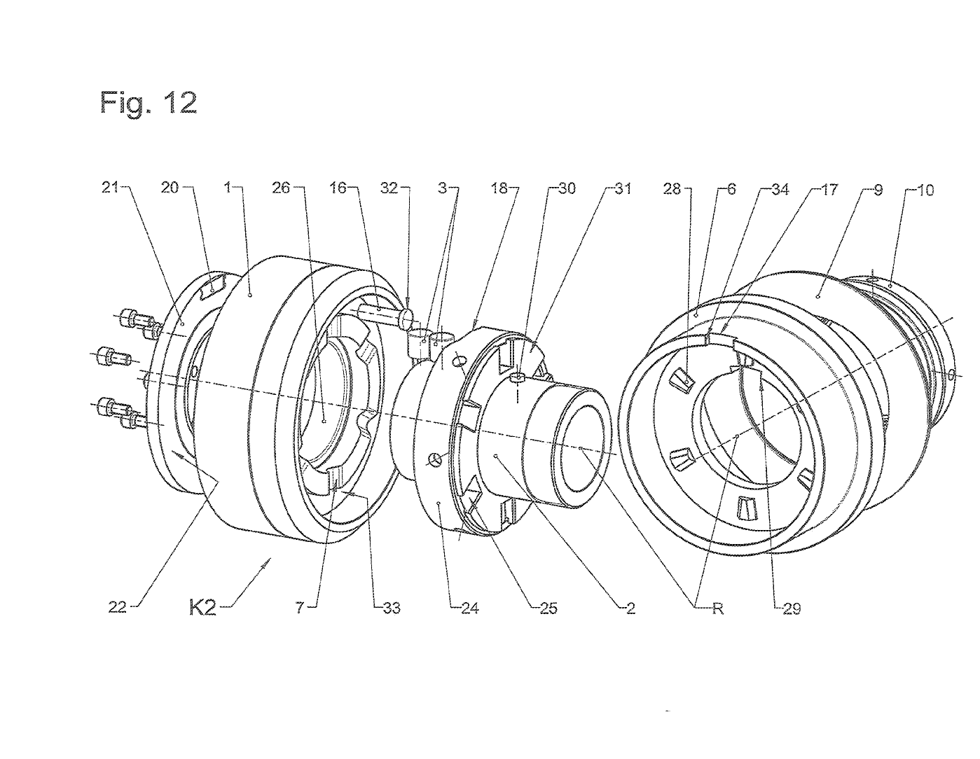

FIG. 12 an exploded diagram of the clutch of FIG. 10,

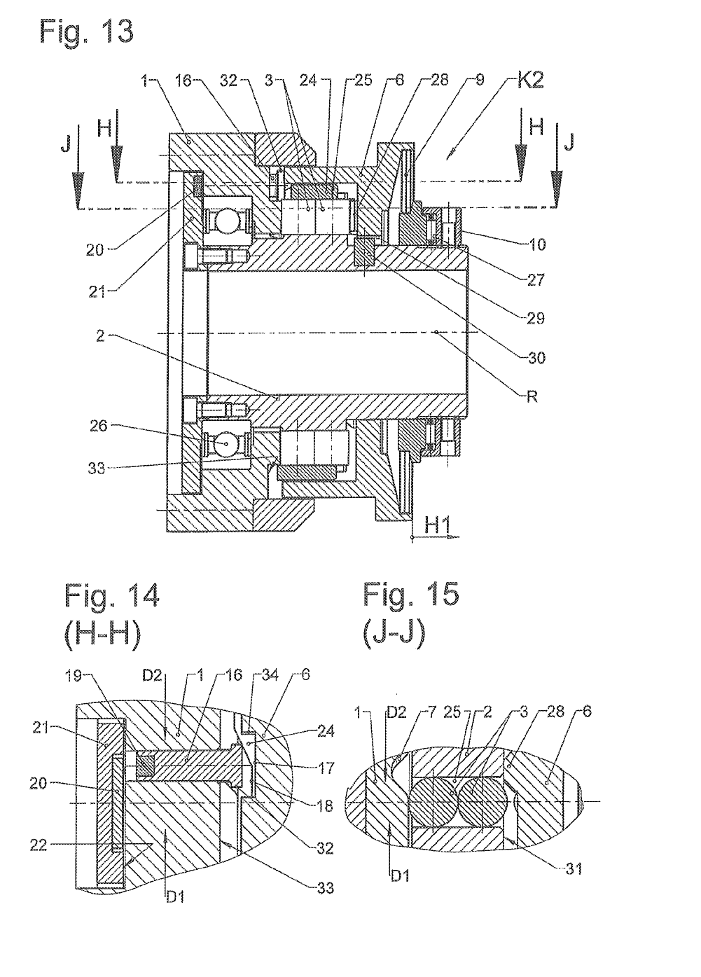

FIG. 13 a longitudinal section of a clutch having cylindrical rollers for torque transfer additionally equipped with the features of the invention, wherein the representation shows the clutch in the disengaged condition,

FIG. 14 a longitudinal section H-H through the clutch of FIG. 13,

FIG. 15 a further longitudinal section J-J through the clutch of FIG. 13,

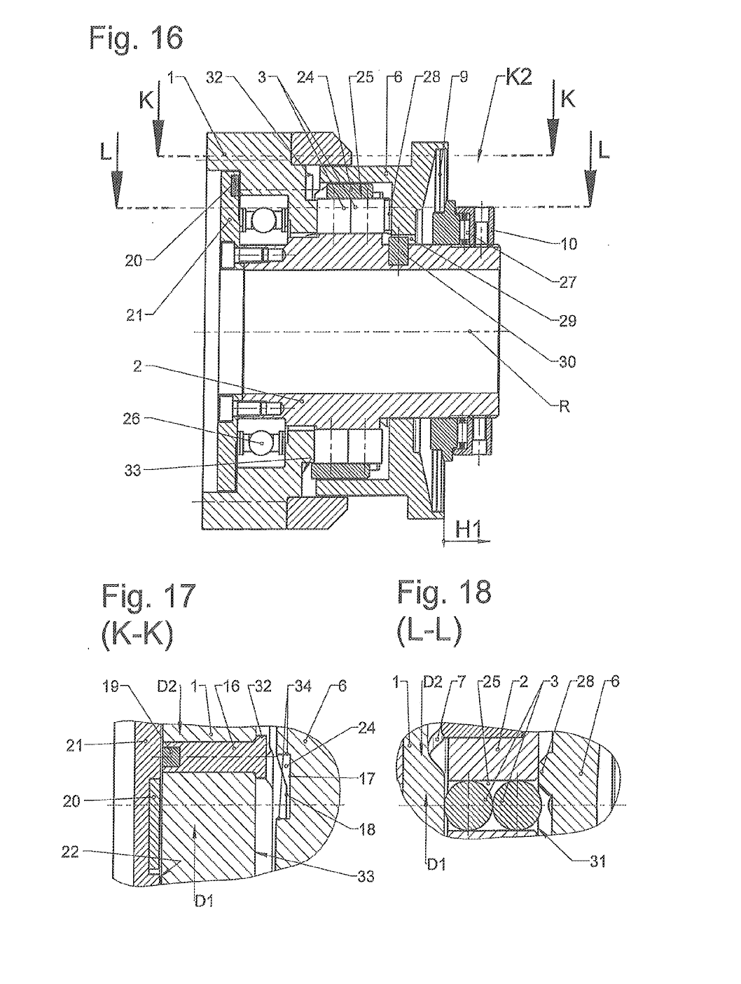

FIG. 16 a further longitudinal section through a clutch with cylindrical rollers for torque transfer additionally equipped with the features of the invention, wherein the representation shows the clutch in the disengaged state,

FIG. 17 a longitudinal section K-K through the clutch of FIG. 16,

FIG. 18 a longitudinal section L-L through the clutch of FIG. 16.

In FIG. 1, FIG. 2 and FIG. 3 a disengaging clutch (K1) is shown, which represents the basic concepts of the above-described clutch according to the state of the art which, however, also possesses the features of the present invention.

This basic function of this disengaging clutch with respect to the torque transfer and disengagement is in accordance with the state of the art as known from DE 37 27 484 C2: according to this torque transfer follows through the pressure flange (1) through transmission bodies (3) placed within apertures in cage (4) to the switch element (6), then through gear-toothing (5) to the clutch hub (2). The transmission bodies (3) here portrayed as balls are hereby by way of the force of spring elements (9) held in recesses (7, 8) of the pressure flange and the switch element (6), whereby the pretension of the spring element (9) is adjustable by way of an adjusting nut (10).

Upon disengagement of the clutch resultant from an excessive torque the transmission bodies (3) move in a rolling motion out of the cone-shaped recesses (7, 8) of the pressure flange (1) and the switch element (6), wherein the cage (4) twists around the rotational axis (R) of the clutch hub (2), further where support bodies (11) arranged in further recesses of the cage (4) and also represented as balls emerge from their support body recesses in the switching unit and enter the support recesses (13) of the switch element (6) adjacent on the same reference circle and then support the force of the spring elements (9) on the thrust bearing (14). Thereby the switching unit (6) forms a stroke movement (H1) and the transmission bodies (3) enter supplementary recesses (15) in the switching unit (6) and therein are held by the cage (4) and thereby are no longer in contact with the pressure flange (1). The clutch (K1) can then freely run down to a standstill of the rotational movement between the pressure flange (1) and the clutch hub (2).

As with the state of the art, re-engagement of the disengaging clutch (K1) is also affected with the clutch having the features of the present invention by reversing the rotational direction between the pressure flange (1) and the clutch hub (2). This is where the control pins (16) inserted in axial bores of the pressure flange (1) become effective by interacting with a control groove (17) of the cage (4) and a control cam (18) of the switch element (6).

In contrast to the state of the art the control pins (16) of the disengaging clutch (K1) according to the invention are not held in contact with the cage (4) and the control cam (18) of the switch element (6) through pressure springs, but through the mutually repulsive force of two interacting permanent magnets (19, 20).

For this, a permanent magnet denoted as a pin magnet (19) is arranged on the side of the control pin (16) removed from the switch element (6) and the cage (4). The loading of the one (or more) control pin(s) (16) towards the switch element (6) is achieved in that each of the respective pin magnets (19) stands opposite one (or more) control magnet(s) (20) which are embedded in a control plate (21) bound to the clutch hub at the same radius as the pin magnet (2) (19), wherein the control magnet(s) (2) opposing the pin magnet (19) are poled such that they repel the latter.

From FIG. 2 and FIG. 3 can be seen that for every control control pin (16) provision of a control magnet (20) is envisaged whereby the control magnet (20) on the control plate (21) as viewed from the circumferential direction of FIG. 2/3 lies in the exact angular position such that engagement of the disengaging clutch (K1) through interaction of control pins (16) control cams (18) and control groove (17) is possible as the latter is known from DE 37 27 484 C2.

A particularly advantageous embodiment of the control magnets (20) is shown in FIG. 3, wherein this is depicted as a rectangle whose long sides are oriented in the circumferential direction of the disengaging clutch (K1) as can be seen in FIG. 3.

Upon disengagement of the disengaging clutch (K1) according to FIG. 1 the pressure flange (1) with the control pins (16) turns relative to the clutch hub (2) with the control plate (21) and the control magnets (20). On the one hand, the control pins (16) thereby leave the angular region in which the interaction of the control pins (16), control cams (18) and control grooves (17) makes a re-engagement of the disengaging clutch (K1) possible and on the other hand the control pins (16) leave the area of repelling influence of the control magnets (20) to the extent that the pin magnets stand opposite the control area (22) of the control plate (21) composed preferably of ferromagnetic material and as a result of this are attracted thereby.

A result is that the respective control pin (16) is only brought into contact with the control cam (18) and control groove (17) at that angular position in which a re-engagement of the disengaging clutch can follow, as this is known from the state of the art according to DE 37 27 484.

In all other angular positions, because of the attraction between the pin magnets (19) and the ferromagnetic control plate (21) no contact between control pins (16), control cam (18) and control groove (17) takes place, whereby wear and noise production of clutch as a whole is heavily reduced.

On running down of the clutch upon disengagement at high revolutions the pin magnet (19) and the arrangement of control magnets (20) move past each other very quickly, wherein the repulsive force between the magnets (19) and (20) only operates for a very short time such that the control pin(s) (16) on account of their inertia remain in their positions separated from the switch element (6) and the cage (4)—thereby allowing a completely contact-free running down.

Only upon reverse rotation of the pressure flange (1) and clutch hub (2) at low speed can a sufficient repulsive force develop between the arrangement of control magnets (20) and the opposed pin magnet (19) such that the control pin(s) (16) can follow and, in interaction with the control cam (18) and the control groove, a re-engagement of the disengaging clutch (K1) is affected as is known as such from the state of the art according to DE 32 27 484 C2.

FIGS. 4-6 show a further improved variant of the disengaging clutch according to the invention. To further optimize the performance of the disengaging clutch (K1) further support magnets (23) can be adorned on the same reference circle of the control plate (21) next to the arrangement of control magnets (20) with polarity such that these attract the pin magnets (19). This is particularly noticeable in FIG. 5 and FIG. 6. Through this measure the attractive forces between the pin magnets (19) and the control plate (21) adorned with support magnets (23) is increased in those angular positions in which the geometric consolation of control pins (16) control cam (18) and control groove (17) would not allow a re-engagement of the disengaging clutch (K1). The contactless running down of the disengaging clutch, in particular from higher revolutions is thereby further optimized.

Further, particularly in the case of vertical installation of the disengaging clutch (K1) in a position in which the control pins (16) are moved towards the control cam (18) and control groove (17) by virtue of their own weight, the support magnets (23) further improve the contactless rundown of the disengaging clutch.

Further, as with the above-described state of the art the disengaging clutch (K1) depending on the particular design of the functional parts can be equipped with one or more control pins (16), each having a respective pin magnet (19).

Accordingly, the number of necessary arrangements of control magnets (20), control cams (18) of the switch element (6) and control grooves (17) of the cage (4) is increased.

The representations of FIG. 7, FIG. 8 and FIG. 9 show a further embodiment of a disengaging clutch (K2) embracing the features of the invention. The clutch is depicted in the engaged state. Analogous to the clutch described at the outset according to the state of the art, the disengaging clutch (K2) also comprises a driven pressure flange (1) having wedge-shaped recesses (7) from which torque is transmitted by way of transmission bodies (3), here depicted as cylindrical rollers to the hub recesses (25) of the clutch hub (2). The pressure flange (1) and clutch hub (2) are rotationally mounted to one another by way of a clutch bearing (26).

Also with this disengaging clutch (K2) the transmission bodies (3) are held in the recesses (7) of the pressure flange (1) by way of switch element (6) charged with spring elements (9), wherein the pre-tension of the spring elements (9) is adjustable by way of an adjusting nut (10).

Additionally, the thrust bearing (27) is provided between the adjusting nut (10) and the spring elements (9), which technical necessity and function is elucidated on below.

At the contact points with the transmission bodies (3) the switch element (6) is adorned with switch unit lobes (28), which protrude in the axial direction into the hub recesses (25) of the clutch hub (2) such that by way of this locking to the clutch hub (2) in the engaged state the switch element (6) and the clutch hub (2) of the disengaging clutch (K2) cannot turn relative to one another.

As shown in FIG. 10 and, in particular, FIG. 11 on its inner circumference the switch element (6) is adorned with switch element stops (29), which correspond to the radially-arranged stop bodies (30) of the clutch hub (2), which upon disengagement of the disengaging clutch (K2) allow only limited movement between the switch element (6) and the clutch hub (2) on the rotational axis (R) of the disengaging clutch (K2).

FIG. 12 provides a further overview of the essential functional parts of the disengaging clutch (K2) and clarifies their geometrical arrangement.

Below is described how the disengaging clutch (K2) is transferred from the engaged position to the disengaged position depicted in FIG. 13, FIG. 14 and FIG. 15.

On disengagement of the disengaging clutch (K2) as a result of an unallowable excessive torque a rotation of the pressure flange (1) occurs in a first rotational direction (D1) of the pressure flange (1) in relation to the clutch hub (2), wherein the transmission bodies (3) move from the wedge-shaped recesses (7) of the pressure flange (1) in a rolling motion and the switch element performs a lifting movement (H1) against the force of the spring elements (9) in the direction of the adjusting nut (10).

In that there are an even number of transmission bodies (3) in each of the hub recesses (25) the rolling movement between the pressure flange (1) and the transmission bodies (3) via the switch element lobes (28) is transferred to the switch element (6) in such a way that the pressure flange (1) and the switch element (6) turn in the same first direction of rotation (D1) in relation to the clutch hub (2). Rotation between the switching element (6) and the clutch hub (2) is facilitated through the previously mentioned thrust bearing (27) (between the spring elements (9) and the adjusting nut (10)).

As a result of the described simultaneous occurrence of the lifting movement (H1) and the rotational movement of the switch element (6) in relation to the clutch hub (2) as is known from the state of the art, the switch element lobes (28) come out of contact with the hub recesses (25), the switch element (6) twists in relation to the clutch hub (2) until the switch element stop (29) contacts the stop (30) of the clutch hub (2) and finally the force of the spring elements (9) are carried by the switch element lobes (28) on the support surface (31) of the clutch hub (2).

In this disengaged condition the disengaging clutch (K2), the transmission bodies are no longer pressed by the spring elements (9) into the recesses (7) of the pressure flange (1), whereby the pressure flange (1) and the clutch hub (2) can run down freely in relation to each other.

At the same time the interaction between the switch element stop (29) and the stop bodies (30) according to FIG. 12 guarantees that switch element lobes (28) cannot protrude into the hub recess (25) nearest in the direction of rotation (D1).

On running down of the disengaging clutch (K2) the switch element (6) is turned in relation to the clutch hub (2) in the depicted first rotation direction (D1) and the switching unit lobes (28) are supported on the support surface (31) of the clutch hub (2).

At the same time the pressure flange (1) turns in relation to the clutch hub (2) likewise in the represented first rotation direction (D1), wherein the unloaded transmission bodies (3) lie in the hub recesses (25) and wherein, as a result, the recesses (7) of the pressure flange (1) move freely under the transmission bodies (3). Together with the pressure flange (1), the control pins (16) adorned with pin magnets (19) move past the control plate (21) which is fastened to the clutch hub (2).

In the region of the control magnets (20) embedded in the control plate (21) according to the invention the pin magnets (19) interacting with these are repelled therefrom and the control pins (16) respectively through their pin bases (32) come into contact with the retaining ring (24) attached to the clutch hub (2) and with the control grooves (17) of the switch element (6).

The pin bases (32) of the control pins (16) thereby protrude into the control grooves (17) of the switch element (6) and are once again guided out of the control grooves (17) by the ramps on the control cams (18) as is to be deemed known from the state of the art.

Lastly, FIGS. 16-18 show how upon further rotation of the pressure flange (1) in the first rotational direction (D1) the control pins (16) leave the region in which the pin magnets (19) and the control magnets (20) are opposed to each other and where the latter can be repelled. The control pins (16) with the pin magnets (19) are then attracted by the control plate (21) formed from a ferromagnetic material until the pin base (32) lies against the pressure flange surface (33); this means that the control pins (16) are drawn away from and held separated from the control cams (18) and control grooves (17). It is thus important that the length of the control pins (16), the axial extent of the pin bases (32) and the axial position of the pressure flange surface (33) are so mutually determined that contact between the pin magnets (19) and the control plate (21) with the control magnets (20) is impossible.

To re-engage the disengaging clutch (K2) the direction of rotation of the pressure flange (1) in relation to the clutch hub (2) is reversed into the second represented rotation direction (D2) (see FIG. 17/18) as is apparent from FIG. 14, FIG. 15, FIG. 17 and FIG. 18.

When thereby the pin magnets (19) stand opposite or rather are aligned in the circumferential direction with control magnets (20) executed as rectangular magnets, the control pins (16) are impinged upon or rather pushed to the control cams (18) of the support ring (24) and the control grooves of the switch element (6) and the pin ends (32) protrude into the control grooves (17).

On further turning of the pressure flange (1) in the second rotational direction (D2) the pin bases (32) come into contact with the groove flanks (34) and the switching element (6) is once again rotated to the initial position in relation to the clutch hub (2). Thus the switching element lobes (28) once again protrude into the hub recesses (25) of the clutch hub (2) and once again transmit the force of the spring elements (9) onto the transmission bodies (3) within the recesses (7) of the pressure flange (1).

Thus, the disengaging clutch (K2) is once again ready for operation and can once again transmit the full torque as defined by the strength of the spring elements (9).

The disengaging clutches (K1, K2) as described with the help of the figures is largely symmetrically constructed such that they may be operated in both rotational directions (D1, D2) and so that the re-engagement at low speed will always be in the opposite rotational direction to the preceding disengagement.

In relation to the disengaging clutch (K2) described in relation to FIG. 7 to FIG. 18 with transmission bodies (3) taking the form of cylindrical rollers it is also conceived that the cylindrical rollers may be substituted for balls or other rotationally symmetrical bodies. The hub recesses (25) can thus be beneficially matched to the shape of the transmission bodies (3) and, for example, with the use of balls as transmission bodies (3) can be executed as bores in the clutch hub (2) running axially and parallel to the rotational axis (R).

### LIST OF REFERENCE SIGNS

1 Pressure flange
2 Clutch hub
3 Transmission bodies, balls with clutch K1, rollers with clutch K2
4 Cage
5 Hub toothing
6 Switch element
7 Recess of the pressure flange
8 Recess of the switch element
9 Spring elements
10 Adjusting nut
11 Support bodies
12 Support body recess
13 Support recess
14 Axial bearing
15 Supplementary recess
16 Control pins
17 Control groove
18 Control cam
19 Pin magnet
20 Control magnet
21 Control plate
22 Control surface
23 Retention magnet
24 Retaining ring
25 Hub recess
26 Clutch bearing
27 Thrust bearing
28 Switch element lobe
29 Switch element stop
30 Stop bodies
31 Support surface
32 Pin base
33 Pressure flange surface
34 Groove flank
D1 First rotational direction
D2 Second rotational direction
K1 Clutch based on DE 37 274 84 C2
K2 Clutch based on new roller concept
R Rotational axis
H1 Lifting movement of the switching unit

1. Interlocking disengaging overload clutch,
with a clutch hub (2) and a pressure flange (1) having axially aligned recesses (7) rotationally mounted on the clutch hub (2),
wherein rotationally symmetrical transmission bodies (3) are arranged on a reference circle, these being held in recesses (7) of the pressure flange (1) through the force of spring elements (9) and thereby transmit a torque from pressure flange (1) to the clutch hub (2),
whereby the clutch is transferred from an engaged condition to a disengaged condition through an overload between clutch hub (2) and pressure flange (1) in a first rotational direction (D1),
whereby re-engagement of the clutch follows from a rotation between clutch hub (2) and pressure flange (1) in a second opposite rotational direction (D2), and
wherein the re-engagement of the clutch follows from the interaction between control pins (16) arranged in axially oriented openings of the pressure flange (1), control cams (18) rotationally securely fastened to the clutch hub (2) and further control grooves (17) with groove flanks (34), characterized in that the control pins (16) are fitted with pin magnets (19) which are impinged upon a force by control magnets (20) firmly mounted on the clutch hub (2), which bring the control pins (16) into engagement with the control cams (18) which are rotationally connected to the clutch hub (2).

2. The interlocking disengaging overload clutch according to claim 1, characterized in that
for torque transmission axially oriented hub recesses (25) are arranged in the clutch hub (2) on a reference circle, in each lying an even number of rotationally symmetrical transmission bodies (3) placed one behind another in the axial direction,
that the transmission bodies (3) situated in the hub recesses (25) are impinged on by the force of the spring elements (9) through switch element lobes (28) of the switch element (6), and
that in the engaged condition of the clutch the switching unit lobes (28) axially mesh with the hub recesses (25).

3. Interlocking disengaging overload clutch according to claim 1, characterized in that the control grooves (17) for the interaction of control pins (16), control cams (18) and control grooves (17) on re-engagement of the clutch are arranged on the switch element (6).

4. Interlocking disengaging overload clutch according to claim 1, characterized in that that for torque transmission to an axially arranged hub toothing (5) of the clutch hub (2) a with this rotationally secured and axially movable switch element (6) is arranged, wherein transmission bodies (3) for torque transmission are arranged in a reference circle and positioned in a cage (4) and are held in positionally opposed recesses of the pressure flange and switch element (7, 8) by the force of spring elements (9).

5. Interlocking disengaging overload clutch according to claim 1, characterized in that control grooves (17) for the interaction upon re-engagement of the clutch between control pins (16), control cams (18) and control grooves (17) are arranged on the cage (4).

6. Interlocking disengaging overload clutch according to claim 1, characterized in that the control magnets (20) are arranged on a reference circle on the face of a control plate (21) fixed securely to the clutch hub (2).

7. Interlocking disengaging overload clutch according to claim 1, characterized in that the face of the control plate (21) lying on the reference circle of the control magnets (20) is composed of a ferromagnetic material.

8. Interlocking disengaging overload clutch according to claim 1, characterized in that retention magnets (23) are arranged on the face of the control plate (21) on the reference circle of the control magnets (22) and displaced from these in the circumferential direction, which are poled such that they attract the pin magnets (19).

9. Interlocking disengaging overload clutch according to claim 1, characterized in that the arrangement for re-engagement of the clutch comprising control pins (16), control magnet (20), control cam (18) and control groove (17) is arranged at least once on the circumference of the clutch.

10. Interlocking disengaging overload clutch according to claim 1, characterized in that the arrangement for re-engagement of the clutch comprising control pins (16), control magnet (20), control cam (18) and control groove (17) is arranged multiple times on the circumference of the clutch.
